(19) United States
(12) Patent Application Publication
(10) Pub. No.: US 2005/0207010 A1
(43) Pub. Date: Sep. 22, 2005

(54) Optical isolator and method of producing the same

(75) Inventors: Yuichi Tokano, Sendai-shi (JP); Tomohiro Yonezawa, Sendai-shi (JP); Yujiro Katoh, Sendai-shi (JP)

Correspondence Address: FRISHAUF, HOLTZ, GOODMAN & CHICK, PC, 220 5TH AVE FL 16, NEW YORK, NY, 10001-7708, US

(73) Assignee: NEC TOKIN Corporation, Sendai-shi (JP)

(21) Appl. No.: 11/080,271

(22) Filed: Mar. 16, 2005

(30) Foreign Application Priority Data
Mar. 18, 2004 (JP) 2004-77308

(51) Int. Cl. G02B 5/30; G02B 27/28

(52) U.S. Cl. 359/501; 359/497

(57) ABSTRACT

An optical isolator comprises a Faraday rotator for non-reciprocally rotating a polarization plane of light, and two polarizers joined to both sides of the Faraday rotator. Each of the polarizers is processed into a spherical surface to form a lens for converging or diverging light passing through the polarizer to form a real image or a virtual image. The optical isolator is formed by joining the two polarizers with the Faraday rotator interposed therebetween and has a generally spherical shape as a whole. The two polarizers may be made of materials different in refractive index from each other.

This application claims priority to prior Japanese patent application JP 2004-77308, the disclosure of which is incorporated herein by reference.

### BACKGROUND OF THE INVENTION

The present invention relates to an optical isolator which permits light to pass through in one direction involving a low loss and shuts off light in the reverse direction. Specifically, the present invention relates an optical isolator which is suitable for shutting off light reflected and returning back to a semiconductor laser diode element and to a method of producing the same.

As a typical example of a light source that generates light by laser oscillation, a semiconductor laser diode element is known. The light generated by the light source of the type is modulated and is utilized for signal transmission. However, an optical circuit in which an optical signal is transmitted is inevitably accompanied by occurrence of reflected return light. The reflected return light travels through the optical circuit in the reverse direction. In most of light sources of the type, therefore, the reflected return light causes various unfavorable phenomena, such as instability of oscillation, generation of optical noise, and instability of optical output. Under the circumstances, it is difficult to perform stable signal transmission when the light is modulated. The reflected return light is generated not only by a plurality of optical parts included in the optical circuit but also by an accident such as breaking of an optical signal line. It is therefore desired to shut off or block the reflected return light.

In order to shut off the reflected return light, use has widely been made of a structure in which a non-reciprocal rotating element is arranged near the semiconductor laser diode element. Combined with a couple of polarizing elements, the non-reciprocal rotating element transmits the light traveling in a signal transmission direction but shuts off the reflected return light. Such a reflected return light shut-off arrangement including the non-reciprocal rotating element as well as the optical polarizing elements is generally called an optical isolator. The optical isolator comprises the non-reciprocal rotating element, two polarizers combined with the non-reciprocal rotating element on both sides thereof, and a magnet. From the limitation owing to the maintenance and the structure of the optical circuit, the optical isolator may be arranged in the middle of the optical circuit, not close to the semiconductor laser diode element. One of the two polarizers which is located on the side opposite to the light source may be called an analyzer.

The non-reciprocal rotating element included in the optical isolator is often called a Faraday rotator. The Faraday rotator has a non-reciprocal rotating function for a vector component which is in parallel with a crystal axis called a C-axis. Therefore, light having an angle such as a diverging or a converging angle has a polarization rotation angle for a component in a C-axis direction of the Faraday rotator. Upon fabrication of the optical isolator, alignment must be carried out taking the diverging or the converging angle into consideration. However, since the diverging or the converging angle is not constant and in view of the productivity, the alignment is often carried out taking a parallel light beam into consideration instead of the diverging or the converging angle.

Referring to FIG. 1, a typical conventional isolator and an optical system used therefor will be described. In FIG. 1, light is outputted by laser oscillation from a semiconductor laser diode chip 1. An optical isolator 2 is arranged in an optical circuit. Before and after the optical isolator 2, lenses 3-1 and 3-2 for diverging or converging the light beam to focus a real image or a virtual image are arranged. The light outputted from the semiconductor laser diode chip 1 is adjusted through the lens 3-1 into a parallel beam 4. Then, the parallel beam 4 passes through the optical isolator 2, is focused again through the lens 3-2, and is inputted to an optical fiber 5.

However, use of the two lenses 3-1 and 3-2 results in a complicated structure and a decrease in productivity of assembling. Under the circumstances, proposal has been made of a technique in which one of the two polarizers included in the optical isolator is given a lens function to diverge or converge the light beam so as to form a real image or a virtual image. In this technique, one of the two polarizers included in the optical isolator which is located on the side of the light source is processed into a curved surface. Such a technique is disclosed in, for example, Japanese Unexamined Patent Application Publication (JP-A) H9-90282 (hereinafter referred to as a document 1).

In the technique disclosed in the document 1, the other polarizer having a flat shape is arranged on the other side of the optical isolator. Therefore, in an assembling step, an optical alignment position varies depending upon an inclination of the optical isolator. As a result, an aligning operation is difficult and limitation is imposed on a package of the optical isolator. Besides, a side surface must be processed into a flat surface because the side surface is used for fixation. As a result, the productivity is decreased.

### SUMMARY OF THE INVENTION

It is therefore an object of the present invention to provide an optical isolator which allows easy alignment in an assembling process without requiring any separate optical system including a lens, and to provide a method of producing the same.

An optical isolator according to the present invention comprises a Faraday rotator for non-reciprocally rotating a polarization plane of light, and two polarizers joined to both sides of the Faraday rotator. According to an aspect of the present invention, each of the two polarizers is processed into a spherical surface to form a lens for converging or diverging light passing through the polarizer to form a real image or a virtual image.

Preferably, the polarizers have such properties as to separate a specific polarization component from a polarization component perpendicular to the specific polarization component.

Preferably, each of the polarizers is made of a material selected from a rutile single crystal, a YVO₄ single crystal, and a LiNbO₃ single crystal.

The polarizers may have such properties as to permit the passage of a specific polarization component and to absorb and extinguish a polarization component perpendicular to the specific polarization component.

Preferably, the optical isolator is formed by joining the two polarizers with the Faraday rotator interposed therebetween, and has a generally spherical shape as a whole.

The optical isolator of a generally spherical shape may be partly ground to form a flat surface which represents the direction of polarization or a fixing surface.

The two polarizers may be made of materials different in refractive index from each other.

According to the present invention, a method of producing an optical isolator is provided. The method comprises the steps of preparing a Faraday rotator and two single-crystal plates as first and second single-crystal plates, applying an organic adhesive onto the first single-crystal plate to adhere and fix one surface of the Faraday rotator thereto, and applying the organic adhesive onto the second single-crystal plate to adhere and fix the other surface of the Faraday rotator thereto. The method further comprises the steps of aligning a polarization axis of the second single-crystal plate and curing the organic adhesive after alignment of the polarization axis to obtain a cured sample, cutting the cured sample to obtain a cut sample of a predetermined size, and polishing the cut sample into a generally spherical shape.

The method may further comprise a step of grinding a part of the optical isolator of a generally spherical shape into a flat surface.

### BRIEF DESCRIPTION OF THE DRAWING

FIG. 1 is a view showing a conventional optical isolator and an optical system combined therewith;

FIG. 2 is a front view of a spherical optical isolator according to an embodiment of the present invention;

FIG. 3 is a perspective view showing an adhered body obtained in the middle of a production process of the optical isolator illustrated in FIG. 2; and

FIG. 4 is a view showing the optical isolator illustrated in FIG. 2 and a measuring system used for measuring the characteristics thereof.

### DESCRIPTION OF THE PREFERRED EMBODIMENT

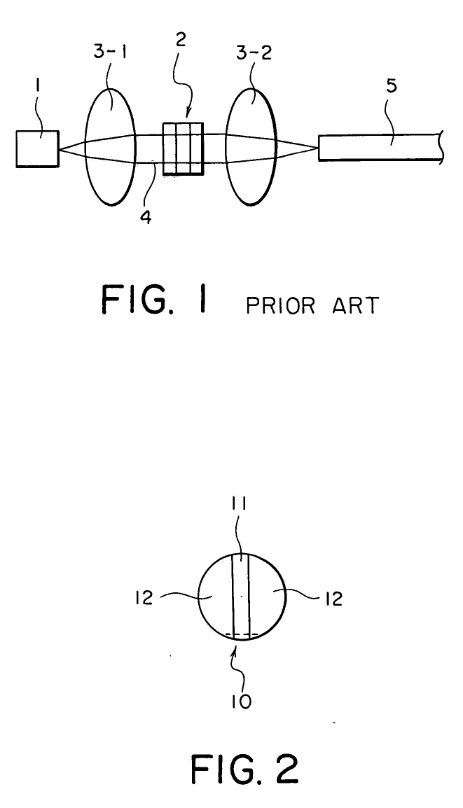

Now, an optical isolator according to the present invention will be described with reference to FIGS. 2 to 4. Referring to FIG. 2, a spherical optical isolator 10 according to an embodiment of the present invention includes a non-reciprocal Faraday rotator 11 for rotating a polarization plane of light, and two polarizers 12 arranged on both sides of the Faraday rotator 11 for selecting specific polarization. The optical isolator 10 further includes a magnet (21 in FIG. 4) arranged outside a combination of the Faraday rotator 11 and the two polarizers 12. The two polarizers 12 are processed into spherical surfaces. As a result, the polarizers 12 are processed into lenses for diverging or converging a light beam to form a real image or a virtual image. One of the two polarizers 12 to which reflected return light is incident serves as an analyzer.

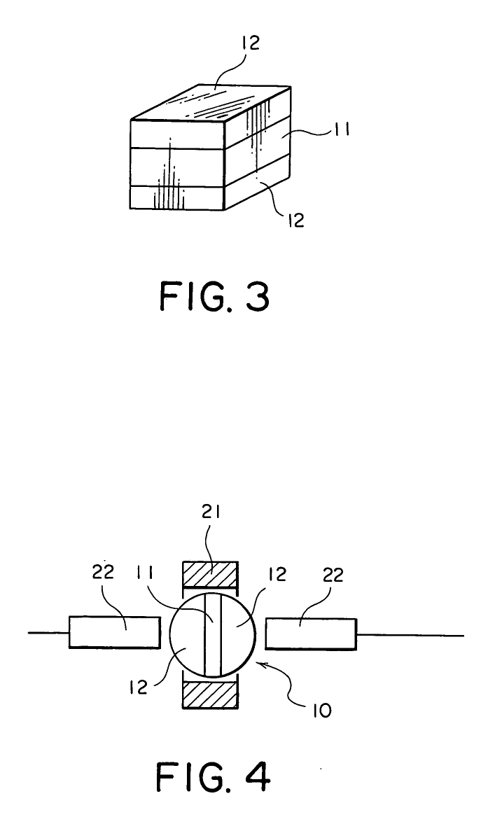

In order to obtain the shape illustrated in FIG. 2, the following process is carried out. Referring to FIG. 3, at first, the polarizers 12 are adhered to the both sides of the Faraday rotator 11. The polarizers 12 and the Faraday rotator 11 adhered to each other are cut to obtain an adhered body of a generally cubic shape. Thereafter, the adhered body as a whole is processed into a generally spherical shape as shown in FIG. 2. The polarizers 12 used herein have such properties as to permit a specific polarization component to travel straight and to separate a polarization component perpendicular to the specific polarization component. Alternatively, use may be made of the polarizers 12 having such properties as to permit the passage of a specific polarization component and to absorb and extinguish a polarization component perpendicular to the specific polarization component. The two polarizers 12 may have the same refractive index. However, if materials different in refractive index are used as the two polarizers 12, it is possible to further decrease and adjust the aberration.

### FIRST EXAMPLE

A first example of the invention will be described below.

In the first example, a GdBiIG garnet film (bismuth-substituted gadolinium iron garnet film) was used as the Faraday rotator to impart non-reciprocal property to the optical isolator. The GdBiIG garnet film had a film thickness of 512 (±2) μm and a rotation angle of 45° for a wavelength of 1.55 μm. The GdBiIG garnet film had both surfaces each of which was coated with an anti-reflection coating having a refractive index of 1.5. As the polarizers, use was made of rutile single-crystal plates having a thickness of 0.9 mm. Each of the rutile single-crystal plates had one surface coated with an anti-reflection coating having a refractive index of 1.0 and the other surface coated with an anti-reflection coating having a refractive index of 1.5. The anti-reflection coating formed on each of the GdBiIG garnet film and the rutile single-crystal plates was designed for a wavelength of 1550 nm. Each of the GdBiIG garnet film and the rutile single-crystal plates used herein had a size of 11 mm square.

The optical isolator in the first example was produced in the manner which will be described below. First, an organic adhesive was applied to a first one of the rutile single-crystal plates on the side of the anti-reflection coating having the refractive index of 1.5. The first rutile single-crystal plate was adhered and fixed to one surface of the GdBiIG garnet film with their ends in alignment. As the organic adhesive, the 353 ND organic adhesive manufactured by Epoxy Technology Inc. was used. Next, the same organic adhesive was applied to a second one of the rutile single-crystal plates on the side of the anti-reflection coating having the refractive index of 1.5. The second rutile single-crystal plate was adhered to the other surface of the GdBiIG garnet film. Then, before the organic adhesive was cured, a laser beam was inputted to the rutile single-crystal plate serving as the analyzer. At the same time, a magnetic field was applied and the polarization axes of the rutile single-crystal plates were brought into alignment so that an extinction ratio was maximized. The organic adhesive was cured after the polarization axes were brought into alignment. Thus, a cured sample was obtained.

The cured sample (cured assembly) was cut into a size of 2.3 mm square by using a dicing saw to obtain the adhered body shown in FIG. 3. The adhered body was polished into a sphere having a diameter of 2.0 mm using wet barrel polishing. Thus, the optical isolator 10 of a spherical shape of R 1.0 mm was obtained as shown in FIG. 2.

The spherical optical isolator 10 was placed in a magnetic field by using a magnet and the characteristics of the optical isolator were measured. Specifically, the GdBiIG garnet film contained in the optical isolator 10 was saturated by applying a saturation magnetic field in the direction of the crystal axis thereof, and the characteristics of the optical isolator were measured. The measuring system has a structure shown in FIG. 4.

In FIG. 4, an annular magnet 21 for saturating the Faraday rotator is arranged around the Faraday rotator 11 near its peripheral end with which the polarizers 12 are not contacted. Optical fibers 22 with ferrules are arranged to face the two polarizers 12, respectively.

As a result of measurement by the above-mentioned measuring system, the optical isolator 10 had the characteristics such that the forward loss was 1.8 dB and the backward loss was 45 dB at a wavelength of 1550 nm. When the optical isolator 10 was further provided with an anti-reflection coating, the forward loss could be improved by about 1.6 dB corresponding to Fresnel reflection loss.

The polarization plate of rutile single crystal permitted normal light to pass through straight but separated abnormal light at a predetermined separation angle. The shifting amount of a separated backward beam was 54.6 μm. Thus, it was found out that the return beam did not reach the semiconductor laser diode chip as the light source.

The optical isolator 10 of the first example had a generally spherical shape. In order to facilitate fixation of the optical isolator or to specify the polarization direction of the polarizers, the optical isolator 10 may be modified as follows. For example, as illustrated in FIG. 2 as a broken line, a part of the optical isolator 10 which does not serve as an optical path may be ground into a flat surface to form a fixing surface. Alternatively, a part of the optical isolator 10 may be provided with a marking. Thus, practical utility could be further improved

### SECOND EXAMPLE

In a second example also, the GdBiIG garnet film was used as the Faraday rotator to impart non-reciprocal property to the optical isolator. The GdBiIG garnet film had a film thickness of 512 (±2) μm and a rotation angle of 45° for a wavelength of 1.55 μm. The GdBiIG garnet film had both surfaces each of which was coated with an anti-reflection coating having a refractive index of 1.5. As the polarizers, use was made of YVO₄ single-crystal plates having a thickness of 1.35 mm. Each of the YVO₄ single-crystal plates had one surface coated with an anti-reflection coating having a refractive index of 1.0 and the other surface coated with an anti-reflection coating having a refractive index of 1.5. The anti-reflection coating formed on each of the GdBiIG garnet film and the YVO₄ single-crystal plates was designed for a wavelength of 1550 nm. Each of the GdBiIG garnet film and the YVO₄ single-crystal plates used herein had a size of 11 mm square.

The optical isolator in the second example was produced in the manner which will be described below. First, an organic adhesive was applied to a first one of the YVO₄ single-crystal plates on the side of the anti-reflection coating having the refractive index of 1.5. The first YVO₄ single-crystal plate was adhered and fixed to one surface of the GdBiIG garnet film with their ends in alignment. As the organic adhesive, the 353 ND organic adhesive manufactured by Epoxy Technology Inc. was used. Next, the same organic adhesive was applied to a second one of the YVO₄ single-crystal plates on the side of the anti-reflection coating having the refractive index of 1.5. The second YVO₄ single-crystal plate was adhered to the other surface of the GdBiIG garnet film. Then, before the organic adhesive was cured, a laser beam was inputted to the YVO₄ single-crystal plate serving as the analyzer. At the same time, a magnetic field was applied and the polarization axes of the YVO₄ single-crystal plates were brought into alignment so that an extinction ratio was maximized. The organic adhesive was cured after the polarization axes were brought into alignment. Thus, a cured sample was obtained.

The cured sample was cut into a size of 3.3 mm square by using a dicing saw to obtain the adhered body shown in FIG. 3. The adhered body was polished into a sphere having a diameter of 3.0 mm using wet barrel polishing. Thus, the optical isolator 10 of a spherical shape of R 1.5 mm was obtained as shown in FIG. 2.

The spherical optical isolator 10 was placed in a magnetic field by using a magnet and the characteristics of the optical isolator were measured. Specifically, the GdBiIG garnet film contained in the optical isolator 10 was saturated by applying a saturation magnetic field in the direction of the crystal axis thereof, and the characteristics of the optical isolator were measured. The measuring system has the structure shown in FIG. 4.

As a result of measurement, the optical isolator 10 had the characteristics such that the forward loss was 1.3 dB and the backward loss was 42 dB at a wavelength of 1550 nm. When the optical isolator 10 was further provided with an anti-reflection coating, the forward loss could be improved by about 1.0 dB corresponding to Fresnel reflection loss.

The polarization plate of YVO₄ single crystal permitted normal light to pass through according to the Snell's law but separated abnormal light at a predetermined separation angle. The shifting amount of a separated backward beam was 75.5 μm. Thus, it was found out that the return beam did not reach the semiconductor laser diode chip as the light source.

In the second example also, the optical isolator 10 had a generally spherical shape. As described in the first example, a part of the optical isolator 10 which does not serve as an optical path may be ground into a flat surface to form a fixing surface. Alternatively, a part of the optical isolator 10 may be provided with a marking. Thus, practical utility could be further improved

### THIRD EXAMPLE

In the third example also, the GdBiIG garnet film was used as the Faraday rotator. The GdBiIG garnet film had a film thickness of 512 (±2) Jim and a rotation angle of 45° for a wavelength of 1.55 μm. The GdBiIG garnet film had both surfaces each of which was coated with an anti-reflection coating having a refractive index of 1.5. As the polarizers, use was made of LiNbO₃ single-crystal plates having a thickness of 1.85 mm. Each of the LiNbO₃ single-crystal plates had one surface coated with an anti-reflection coating having a refractive index of 1.0 and the other surface coated with an anti-reflection coating having a refractive index of 1.5. The anti-reflection coating formed on each of the GdBiIG garnet film and the LiNbO₃ single-crystal plates was designed for a wavelength of 1550 nm. Each of the GdBiIG garnet film and the LiNbO₃ single-crystal plates used herein had a size of 11 mm square.

The optical isolator in the third example was produced in the manner which will be described below. First, an organic adhesive was applied to a first one of the LiNbO₃ single-crystal plates on the side of the anti-reflection coating having the refractive index of 1.5. The first LiNbO₃ single-crystal plate was adhered and fixed to one surface of the GdBiIG garnet film with their ends in alignment. As the organic adhesive, the 353 ND organic adhesive manufactured by Epoxy Technology Inc. was used. Next, the same organic adhesive was applied to a second one of the LiNbO₃ single-crystal plates on the side of the anti-reflection coating having the refractive index of 1.5. The second LiNbO₃ single-crystal plate was adhered to the other surface of the GdBiIG garnet film. Then, before the organic adhesive was cured, a laser beam was inputted to the LiNbO₃ single-crystal plate serving as the analyzer. At the same time, a magnetic field was applied and the polarization axes of the LiNbO₃ single-crystal plates were brought into alignment so that an extinction ratio was maximized. The organic adhesive was cured after the polarization axes were brought into alignment. Thus, a cured sample was obtained.

The cured sample was cut into a size of 4.2 mm square by using a dicing saw to obtain the adhered body shown in FIG. 3. The adhered body was polished into a sphere having a diameter of 4.0 mm using wet barrel polishing. Thus, the optical isolator 10 of a spherical shape of R 2.0 mm was obtained as shown in FIG. 2.

The spherical optical isolator 10 was placed in a magnetic field by using a magnet and the characteristics of the optical isolator were measured. Specifically, the GdBiIG garnet film contained in the optical isolator 10 was saturated by applying a saturation magnetic field in the direction of the crystal axis thereof, and the characteristics of the optical isolator were measured. The measuring system has a structure shown in FIG. 4.

As a result of measurement, the optical isolator 10 had the characteristics such that the forward loss was 1.85 dB and the backward loss was 40 dB at a wavelength of 1550 nm. When the optical isolator 10 was further provided with an anti-reflection coating, the forward loss could be improved by about 1.6 dB corresponding to Fresnel reflection loss.

The polarization plate of LiNbO₃ single crystal permitted normal light to pass through according to the Snell's law but separated abnormal light at a predetermined separation angle. The shifting amount of a separated backward beam was 39.1 μm. Thus, it was found out that the return beam did not reach the semiconductor laser diode chip as the light source.

In the third example also, the optical isolator 10 had a generally spherical shape. As described in the first and the second examples, a part of the optical isolator 10 which does not serve as an optical path may be ground into a flat surface to form a fixing surface. Alternatively, a part of the optical isolator 10 may be provided with a marking. Thus, practical utility could be further improved

The polarizers used in the above examples permit normal light components to pass through according to the Snell's law, i.e., permit perpendicularly incident beams to travel straight without causing refraction and separate abnormal light components at a predetermined separation angle. Alternatively, use may be made of the polarizers that permit one polarization component to pass through and absorb and extinguish another polarization component perpendicular to the one polarization component.

Further, if the two polarizers are made of materials different in refractive index, different focal distances can be obtained even when the spherical surfaces of the two polarizers are equal in radius of curvature to each other. Therefore, the optical isolator can be designed so that one polarizer is adapted to a diverging angle of output light from the semiconductor laser diode chip and the other polarizer is adapted to a converging angle of light coupled to an optical fiber.

In the above-mentioned examples, the GdBiIG garnet film is used as the Faraday rotator. However, the material of the Faraday rotator is not limited to the GdBiIG garnet film as far as the function of the Faraday rotator is exhibited.

As described above in conjunction with the several preferred embodiments, the present invention is characterized in that both of the two polarizers of the optical isolator are polished into curved surfaces so as to suppress occurrence of aberration. As a result, light passing through the optical isolator passes through two curved surfaces so that the occurrence of aberration is suppressed.

In order to further improve the aberration, the present invention uses the two polarizers different in refractive index to adjust the curved surfaces. This makes it possible to highly improve the aberration.

Further, the present invention is characterized in that the optical isolator as a whole has a generally spherical shape. This technique leads to significant improvement in tolerance upon the alignment.

As described above, in the optical isolator of the present invention, it is proved that the two polarizers can be formed into the curved surfaces without deteriorating the characteristics and that, by forming the two polarizers into the curved surfaces, the performance is not deteriorated even if lenses contained in a package of the semiconductor laser diode chip are omitted. Thus, the present invention provides an optical isolator which allows easy alignment in an assembling process without requiring any separate optical system including a lens.

The optical isolator according to the present invention can be applied to, for example, a light source device for optical communication, an amplifying device for optical communication, a laser measurement device, and the like.

While the present invention has thus far been described in connection with the preferred embodiment thereof, it will be readily possible for those skilled in the art to put the present invention into practice in various other manners without departing from the scope set forth in the appended claims.

1. An optical isolator comprising a Faraday rotator for non-reciprocally rotating a polarization plane of light, and two polarizers joined to both sides of the Faraday rotator, wherein each of said two polarizers is processed into a spherical surface to form a lens for converging or diverging light passing through said polarizer to form a real image or a virtual image.

2. An optical isolator according to claim 1, wherein said polarizers have such properties as to separate a specific polarization component from a polarization component perpendicular to the specific polarization component.

3. An optical isolator according to claim 2, wherein each of said polarizers is made of a material selected from a rutile single crystal, a YVO4 single crystal, and an LiNbO3 single crystal.

4. An optical isolator according to claim 1, wherein said polarizers have such properties as to permit the passage of a specific polarization component and to absorb and extinguish a polarization component perpendicular to said specific polarization component.

5. An optical isolator according to claim 1, wherein said optical isolator is formed by joining said two polarizers with said Faraday rotator interposed therebetween, and has a generally spherical shape as a whole.

6. An optical isolator according to claim 5, wherein the optical isolator of a generally spherical shape is partly ground to form a flat surface which represents the direction of polarization or a fixing surface.

7. An optical isolator according to claim 1, wherein said two polarizers are made of materials different in refractive index from each other.

8. An optical isolator according to claim 5, wherein said two polarizers are made of materials different in refractive index from each other.

9. An optical isolator according to claim 6, wherein said two polarizers are made of materials different in refractive index from each other.

10. A method of producing an optical isolator, comprising the steps of:
preparing a Faraday rotator and two single-crystal plates as first and second single-crystal plates;
applying an organic adhesive onto the first single-crystal plate to adhere and fix one surface of said Faraday rotator thereto;
applying the organic adhesive onto the second single-crystal plate to adhere and fix the other surface of said Faraday rotator thereto;
aligning a polarization axis of the second single-crystal plate and curing said organic adhesive after alignment of the polarization axis to obtain a cured sample;
cutting the cured sample to obtain a cut sample of a predetermined size; and
polishing the cut sample into a generally spherical shape.

11. A method of producing an optical isolator according to claim 10, further comprising a step of grinding a part of the optical isolator of a generally spherical shape into a flat surface.

12. An optical isolator according to claim 2, wherein said optical isolator is formed by joining said two polarizers with said Faraday rotator interposed therebetween, and has a generally spherical shape as a whole.

13. An optical isolator according to claim 3, wherein said optical isolator is formed by joining said two polarizers with said Faraday rotator interposed therebetween, and has a generally spherical shape as a whole.

14. An optical isolator according to claim 4, wherein said optical isolator is formed by joining said two polarizers with said Faraday rotator interposed therebetween, and has a generally spherical shape as a whole.

15. An optical isolator according to claim 12, wherein the optical isolator of a generally spherical shape is partly ground to form a flat surface which represents the direction of polarization or a fixing surface.

16. An optical isolator according to claim 13, wherein the optical isolator of a generally spherical shape is partly ground to form a flat surface which represents the direction of polarization or a fixing surface.

17. An optical isolator according to claim 14, wherein the optical isolator of a generally spherical shape is partly ground to form a flat surface which represents the direction of polarization or a fixing surface.

18. An optical isolator according to claim 2, wherein said two polarizers are made of materials different in refractive index from each other.

19. An optical isolator according to claim 3, wherein said two polarizers are made of materials different in refractive index from each other.

20. An optical isolator according to claim 4, wherein said two polarizers are made of materials different in refractive index from each other.
